(19) United States
(12) Patent Application Publication
(10) Pub. No.: US 2016/0036084 A1
(43) Pub. Date: Feb. 4, 2016

(54) FUEL CELL STACK

(71) Applicants: Hyundai Motor Company, Seoul (KR); Kia Motors Corporation, Seoul (KR)

(72) Inventors: Duck-whan Kim, Seongnam (KR); Yongsuk Heo, Seoul (KR); Suk-min Baeck, Seongnam (KR)

(21) Appl. No.: 14/560,982

(22) Filed: Dec. 4, 2014

(30) Foreign Application Priority Data
Aug. 1, 2014 (KR) 10-2014-0099205

(51) Int. Cl. H01M 8/24; H01M 8/04

(52) U.S. Cl. CPC H01M 8/2485; H01M 8/04201; H01M 8/04074; H01M 2250/20

(57) ABSTRACT

Disclosed herein is a fuel cell stack. The fuel cell stack includes: at least one unit stack comprising an assembly of unit cells and an enclosure protecting the unit stack. In particular, reaction gas inlet/outlet channels for supplying reaction gas to the unit stack are formed on a first side surface of the enclosure, and coolant inlet/outlet channels for supplying coolant to the unit stack are formed on a second side surface of the enclosure.

### CROSS-REFERENCE TO RELATED APPLICATION

This application claims priority to and the benefit of Korean Patent Application No. 10-2014-0099205 filed in the Korean Intellectual Property Office on Aug. 1, 2014, the entire contents of which are incorporated herein by reference.

### TECHNICAL FIELD

The present invention relates to a fuel cell stack. The fuel cell stack includes an assembly structure of a unit stack and an enclosure.

### BACKGROUND

A fuel cell system generates electric energy through an electrochemical reaction of hydrogen and oxygen and may be used in a fuel cell vehicle.

The fuel cell system includes a fuel cell stack, a hydrogen supply part supplying hydrogen to the fuel cell stack, an air supply part supplying air to the fuel cell stack, and a heat/water control part configured to remove reaction heat and water from the fuel cell stack and adjust a temperature of the fuel cell stack.

The fuel cell stack includes a unit stack in which a plurality of unit cells are bundled together and an enclosure for protecting the unit stack. Alternatively, the fuel cell stack may include a single stack including a plurality of unit stacks therein.

The unit stack generates electric energy by the electric chemical reaction of hydrogen and air. In addition, the unit stack generates heat and water as by-products of the reaction, and thus the cooling is performed by a coolant. The enclosure is a component configured to protect the unit stack and includes an under frame, a module bracket, and a cover.

Meanwhile, reaction gas and coolant inlet/outlet channels for supplying hydrogen, air and the coolant to the unit stack are formed in a first side surface of the fuel cell stack.

Since both of the reaction gas and coolant inlet/outlet channels are formed in one side surface of the fuel cell stack, assembling of the fuel cell stack may be facilitated. Here, the reaction gas and coolant inlet/outlet channels which are connected to the unit stack may be formed in a manifold block, separately from the unit stack.

Assembling the fuel cell stack as described above may be performed by mounting the unit stack on the under frame, fixing the manifold block to the unit stack, and coupling the cover in a state in which the unit stack and the under frame are fixed through the module bracket.

The assembling of the fuel cell stack in the related arts as described above may have advantages such that length change of the unit stack and a mass assembly line of the stack may be reduced. However, since the reaction gas and coolant inlet/outlet channels are formed in the first side surface of the fuel cell stack through the manifold block configuration of the manifold block may be complicated.

Meanwhile, in the fuel cell stack, a greater amount of reaction gas is introduced into an inlet cell of the unit stack close to a reaction gas inlet/outlet, and an amount of reaction gas introduced into a distal end cell (end cell) far from the inlet/outlet is decreased.

As the amount of reaction gas supplied to the inlet cell of the unit stack is increased, and the amount of reaction gas supplied to the distal end cell is decreased, as such in the unit stack, a performance deviation may be generated between the entire cells. For example, performance of the inlet cell may be better than that of the distal end cell, and when the same current volume on an I-V curve, a voltage change may be generated in each of the cells.

In other words, a voltage of the inlet cell increase, and a voltage of each of the cells is reduced toward the distal end cell in the constant current volume, which may indicated that heat generation may increase toward the distal end cell.

Further, in the fuel cell stack, a distribution deviation of the coolant may be generated in the unit stacks, such that a flux of the coolant supplied to the inlet cell may increase as compared to the distal end cell of the unit stack.

However, according to the related art, since the reaction gas and coolant inlet/outlet channels are formed in one side surface, in the inlet cell of the unit stack, amount of generated heat is insignificant and the coolant is efficiently supplied, such that performance of the cell is increased. In contrast, in the distal end cell, amount of generated heat is substantial, and a supply amount of coolant is not sufficient, such that performance of the cell is further reduced.

Accordingly, in the unit stack, an average cell voltage depending on a position of the cell at a reference current may have a deviation according to the flux of the coolant, and as the flux of the coolant is reduced, the deviation is further increased.

Further, performance deviation depending on the distribution deviations of the reaction gas and the coolant between the cells of the unit stack is observed under a low temperature flooding condition. In the low temperature flooding condition, on the contrary to a high temperature condition, the inlet cell of the unit stack may be super-cooled, such that performance is rather reduced as compared to the distal end cell. The cell average voltage at the low temperature condition may be gradually reduced by flooding with the passage of time.

As described above, in the fuel cell stack, as the reaction gas and coolant inlet/outlet channels are formed only in the first side surface, the performance deviation between the cells may be generated in the entire unit stack, which is particularly due to temperature non-uniformity caused by the distribution deviation between the cells when fluids of the reaction gas and coolant are supplied.

Since the distal end cell is substantially heated at the high temperature condition and the inlet cell is substantially cooled at the low temperature condition, performance deviation between the cells may be generated, as such, improvement of cooling performance is desired.

The above information disclosed in this Background section is only for enhancement of understanding of the background of the invention and therefore it may contain information that does not form the prior art that is already known in this country to a person of ordinary skill in the art.

### SUMMARY OF THE INVENTION

In a preferred aspect, the present invention provides a fuel cell stack that has simplified manifold block structure. Accordingly, the performance deviation between cells of a unit stack may be minimized by changing positions of reaction gas and coolant inlet/outlet channels with respect to the unit stack and improving a coupling structure of the unit stack and an enclosure.

In an exemplary embodiment, a fuel cell stack may include: at least one unit stack including an assembly of unit cells; and an enclosure protecting the unit stack. Particularly, reaction gas inlet/outlet channels for supplying reaction gas to the unit stack may be formed in a first side surface of the enclosure, and coolant inlet/outlet channels for supplying coolant to the unit stack may be formed in a second side surface of the enclosure.

The enclosure may include a first channel block in which the reaction gas inlet/outlet channels are formed and a second channel block in wich the coolant inlet/outlet channels are formed.

The first channel block may include a first side cover of the enclosure, and the second channel block may include a second side cover of the enclosure.

In an exemplary embodiment, a fuel cell stack may include: at least one unit stack including an assembly of unit cells; and an enclosure protecting the unit stack. In particular, the enclosure may include: a lower cover that protects a lower portion of the unit stack; a first side cover that protects a first side of the unit stack; a second side cover that protects a second side of the unit stack; and an upper cover that protects an upper portion of the unit stack. In addition, reaction gas inlet/outlet channels for supplying reaction gas to the unit stack may be formed in the first side cover, and coolant inlet/outlet channels for supplying a coolant to the unit stack may be formed in the second side cover.

The first side cover may include a first channel block where the reaction gas inlet/outlet channels and fixed to a predetermined mounting part are formed.

The second side cover may include a second channel block where the coolant inlet/outlet channels and fixed to the mounting part are formed.

In addition, a mount bracket fixed to the mounting part may be formed integrally with the first side cover and the second side cover.

Moreover, the first channel block may be connected to the first side of the unit stack through the reaction gas inlet/outlet channel, and the second channel block may be connected to the second side of the unit stack through the coolant inlet/outlet channel.

In the fuel cell stack according to an exemplary embodiment of the present invention, the lower cover may be formed in a “ [symbol] ”, “ [symbol] ”, or “ [symbol] ” cross-sectional shape and is configured to enclose and protect lower portions of the unit stack, the first side cover and the second side cover.

In the fuel cell stack according to an exemplary embodiment of the present invention, the upper cover may be formed in a “ [symbol] ” or “ [symbol] ” cross-sectional shape and is configured to enclose and protect upper portions of the unit stack, the first side cover and the second side cover.

Since in the stack, inlet/outlet channels for supplying the reaction gas and the coolant to the unit stack are separately formed in the first side cover as the first channel block and the second side cover as the second channel block, respectively, manifold block structures of the reaction gas and the coolant may be simplified.

In addition, as the reaction gas inlet/outlet channels are formed in the first side of the enclosure, and the coolant inlet/outlet channels are formed in the second side of the enclosure based on the unit stack, a entire performance deviation between cells of the unit stack may be minimized.

Further provided is a fuel cell system that comprises a fuel cell stack as described herein.

Still further provided is a vehicle that comprises a preferred fuel cell system comprising a fuel cell stack of the invention as described herein.

Also, a preferred assembly of a fuel cell stack may be provided with a fuel cell stack of the invention as described herein.

Other aspects of the invention are disclosed infra.

### BRIEF DESCRIPTION OF THE DRAWINGS

The accompanying drawings are provided in order to describe exemplary embodiments of the present invention, such that technical idea of the present invention is not limited to the accompanying drawings.

FIG. 1 illustrates an exemplary fuel cell stack according to an exemplary embodiment of the present invention.

FIG. 2 illustrates an exemplary assembly cross-sectional configuration of an exemplary fuel cell stack according to an exemplary embodiment of the present invention.

FIGS. 3A to 3C show exemplary lower and upper covers of an exemplary enclosure applied to an exemplary fuel cell stack according to an exemplary embodiment of the present invention.

FIG. 4 illustrates an exemplary first side cover of an exemplary enclosure applied to an exemplary fuel cell stack according to an exemplary embodiment of the present invention.

FIG. 5 illustrates an exemplary second side cover of the an exemplary enclosure applied to an exemplary fuel cell stack according to an exemplary embodiment of the present invention.

FIG. 6 illustrates an exemplary operation effect of an exemplary fuel cell stack according to the exemplary embodiment of the present invention.

FIGS. 7A to 8B are graphs for describing an exemplary operation effect of an exemplary fuel cell stack according to an exemplary embodiment of the present invention.

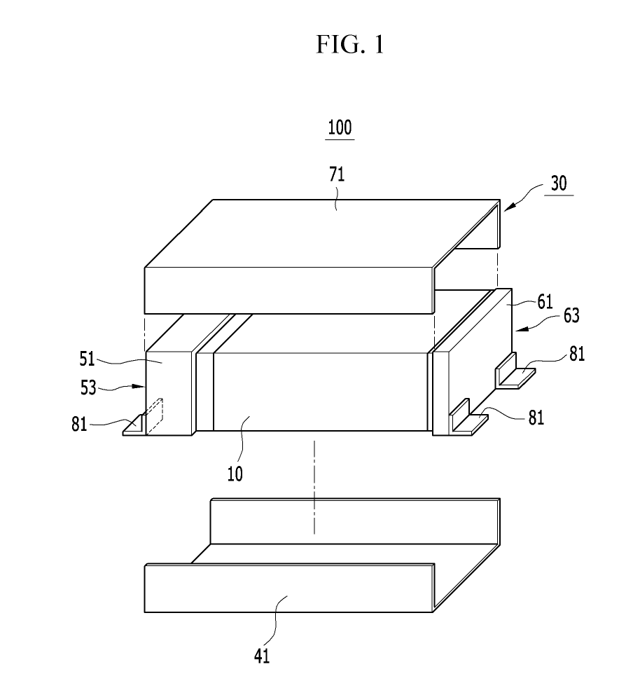

Reference numerals set forth in the FIGS. 1-7 include reference to the following elements as further discussed below:
1 . . . mounting part
10 . . . unit stack
30 . . . enclosure
31 . . . reaction gas inlet/outlet channel
33 . . . coolant inlet/outlet channel
41 . . . lower cover
51 . . . first side cover
53 . . . first channel block
61 . . . second side cover
63 . . . second channel block
71 . . . upper cover
81 . . . mount bracket
91 . . . inlet cell portion
93 . . . distal end cell portion

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The present invention will be described more fully hereinafter with reference to the accompanying drawings, in which exemplary embodiments of the invention are shown, so that those skilled in the art may easily practice the present invention. As those skilled in the art would realize, the described embodiments may be modified in various different ways, all without departing from the spirit or scope of the present invention.

In order to clarify the present invention, parts that are not connected with the description will be omitted, and the same elements or equivalents are referred to with the same reference numerals throughout the specification.

The size and thickness of each element are arbitrarily shown in the drawings, but the present invention is not necessarily limited thereto, and in the drawings, the thickness of portions, regions, etc are exaggerated for clarity.

Moreover, the use of the terms first, second, etc. are used to distinguish one element from another, and are not limited to the order in the following description.

Throughout the specification, unless explicitly described to the contrary, the word “comprise” and variations such as “comprises” or “comprising”, will be understood to imply the inclusion of stated elements but not the exclusion of any other elements.

Further, the terms ‘unit’, ‘means’, ‘-er (-or)’, ‘member’, etc, described in the specification indicate a comprehensive configuration unit for performing at least one function or operation.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

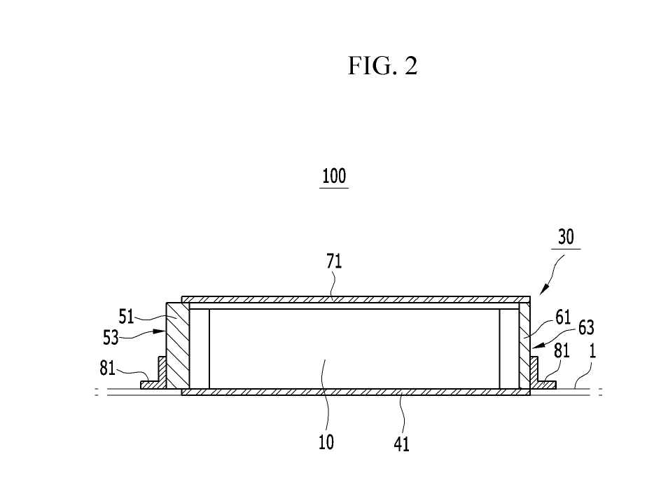

FIG. 1 illustrates an exemplary fuel cell stack according to an exemplary embodiment of the present invention, and FIG. 2 is an exemplary assembly cross-sectional configuration diagram schematically showing an exemplary fuel cell stack according to an exemplary embodiment of the present invention.

Referring to FIGS. 1 and 2, the fuel cell stack 100 according to an exemplary embodiment of the present invention is an electricity generation assembly of unit cells generating electric energy through an electrochemical reaction of hydrogen as fuel, and air as oxidant.

For example, the fuel cell stack 100 may be mounted in a fuel cell vehicle and drive a driving motor using electric energy generated in the fuel cell stack 100 through the electrochemical reaction of hydrogen and air.

The fuel cell stack 100, as described above, may include: one or more unit stacks 10; and an enclosure 30 protecting the unit stack 10.

The unit stack 10 may include a unit assembly of unit cells generating electric energy through the electrochemical reaction of hydrogen and air. The unit cells may be pressed and engaged through an end plate. The unit stack 10 generates heat and water as by-products of the reaction of hydrogen and air, and the cooling may be also performed by a coolant which is a cooling medium.

The unit cell may include separators disposed at both sides of a membrane-electrode assembly (MEA). A reaction channel for supplying hydrogen and air to the MEA and a cooling channel for moving the coolant are respectively formed in the separator. Hereinafter, hydrogen and air supplied to the unit stack 10 in order to generate electric energy will be referred to as “reaction gas” for convenience.

The enclosure 30 is configured to substantially protect the unit stack 10 and mount the unit stack on a predetermined mounting part 1, for example, a vehicle body of the fuel cell vehicle.

The fuel cell stack according to an exemplary embodiment of the present invention configured as described above may have a structure capable of minimizing a performance deviation between cells of the unit stack 10 in addition to simplifying the supply structure of the reaction gas and the coolant to the unit stack 10.

In the fuel cell stack 100, reaction gas inlet/outlet channels 31 for supplying the reaction gas to the unit stack 10 may be formed in a first side of the enclosure 30 and coolant inlet/outlet channels for supplying the coolant to the unit stack 10 are formed in a second side thereof.

The enclosure 30 as described above may include a lower cover 41, a first side cover 51, a second side cover 61, and an upper cover 71.

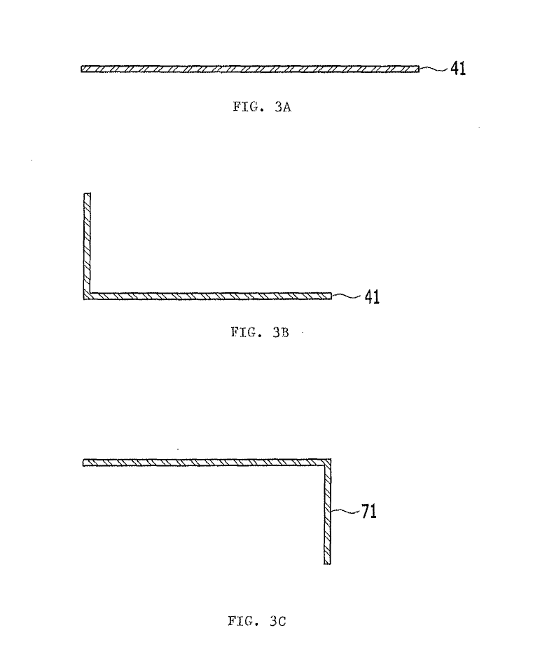

The lower cover 41 is configured to protect a lower portion of the unit stack 10. The lower cover 41 may be formed in a “ [symbol] ” cross-sectional shape so as to protect the lower portion of the unit stack 10 as shown in FIG. 3A. In addition, the lower cover 41 may be formed in a “ [symbol] ” cross-sectional shape so as to enclose and cover lower portions of the first side cover 51 and the second side cover 61 as shown in FIG. 1.

Alternatively, the lower cover 41 may be formed in a “ [symbol] ” cross-sectional shape so as to enclose and cover the lower portions of the first side cover 51 and the second side cover 61 as shown in FIG. 3B.

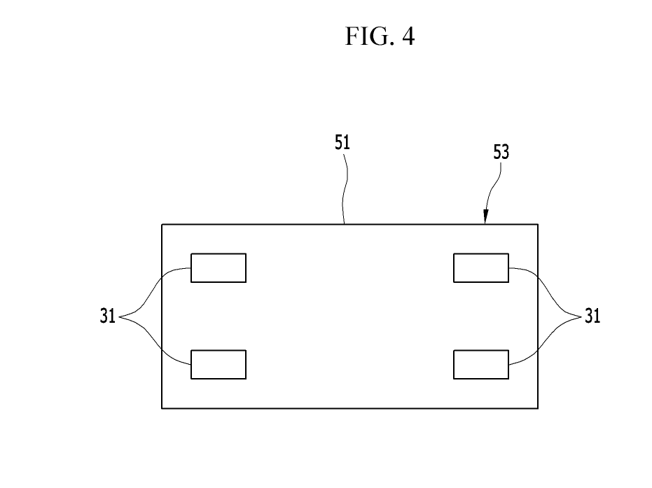

The first side cover 51 is configured to protect the first side of the unit stack 10 and the reaction gas inlet/outlet channels 31 for supplying the reaction gas to the unit stack 10 may be formed in the first side cover 51 as shown in FIG. 4.

Since the first side cover 51 is assembled with the lower cover 41, the first side cover 51 may include a first channel block 53 that is connected to the first side of the unit stack 10 through the reaction gas inlet/outlet channels 31.

The first channel block 53 may be a manifold block in which the reaction gas inlet/outlet channels 31 are formed and may be connected to the first side of the unit stack 10 and fixed to a mounting part 1 of the vehicle body of the fuel cell vehicle through a mount bracket 81 to be described below.

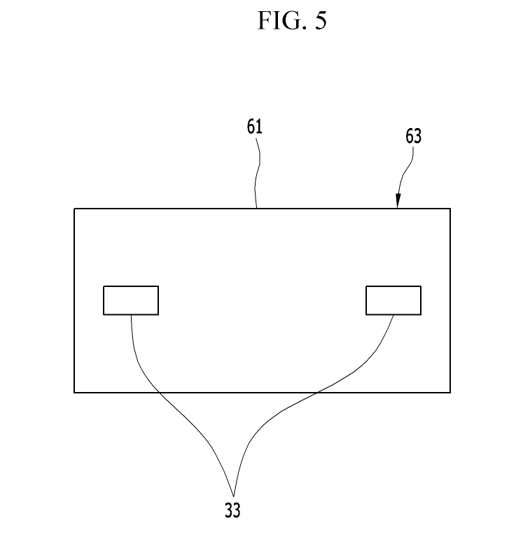

The second side cover 61 is configured to protect the second side of the unit stack 10 and the coolant inlet/outlet channels 33 for supplying the coolant to the unit stack 10 as shown in FIG. 5.

Since the second side cover 61 is assembled with the lower cover 41, the second side cover 61 may include a second channel block 63 connected to the second side of the unit stack 10 through the coolant inlet/outlet channels 33.

The second channel block 63 may be a manifold block in which the coolant inlet/outlet channels 33 may be formed and may be connected to the second side of the unit stack 10 and fixed to the mounting part 1 through a mount bracket 81 to be described below.

The upper cover 71 is configured to protect an upper portion of the unit stack 10 and may be assembled with the first side cover 51 and the second side cover 61. The upper side cover 71 may be formed in a “ [symbol] ” cross-sectional shape so as to enclose and cover the upper portion of the unit stack 10 and upper portions of the first side cover 51 and the second side cover 61.

Alternatively, the upper cover 71 may be formed in a “ [symbol] ” cross-sectional shape so as to enclose and cover the upper portions of the first side cover 51 and the second side cover 61 to be described below as shown in FIG. 3C.

Meanwhile, the enclosure 30 according to an exemplary embodiment of the present invention may further include the mount bracket 81 for mounting the first side cover 51 and the second side cover 61 to the mounting part 1 of the vehicle body of the fuel cell vehicle.

The mount bracket 81 may have a “ [symbol] ” cross-sectional shape and be provided integrally with the first side cover 51 and the second side cover 61. The mount bracket 81 may be fixed to the mounting part 1 by a mount bolt (not shown).

In the fuel cell stack 100 as described above, the first side cover 51 of the enclosure 30 may include the first channel block 53 in which the reaction gas inlet/outlet channel 31 may be formed for supplying the reaction gas to the unit stack 10.

Further, the second side cover 61 of the enclosure 30 may include the second channel block 63 in which the coolant inlet/outlet channel 33 may be formed for supplying the coolant to the unit stack 10.

As such, the reaction gas inlet/outlet channels 31 for supplying the reaction gas to the unit stack 10 may be formed in the first side of the enclosure 30, and the coolant inlet/outlet channels 33 for supplying the coolant to the unit stack 10 may be formed in the second side of the enclosure 30.

Accordingly, since the inlet/outlet channels 31 and 33 for supplying the reaction gas and the coolant to the unit stack are separately formed in the first side cover 51 as the first channel block 53 and the second side cover 61 as the second channel block 63, respectively, manifold block structures of the reaction gas and the coolant may be simplified.

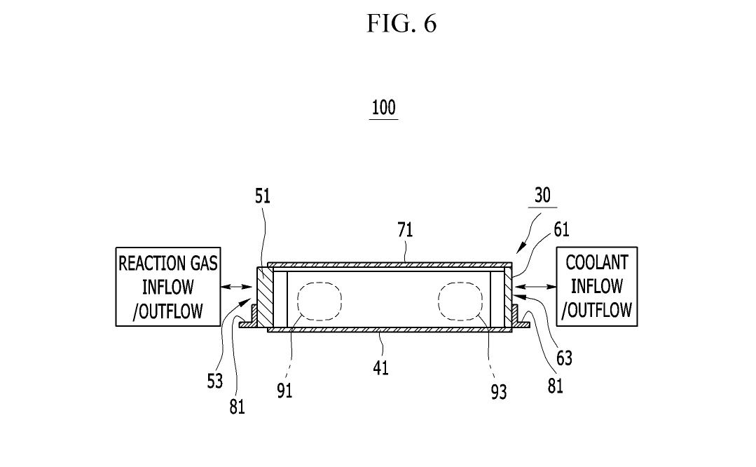

Meanwhile, a greater amount of the reaction gas may be introduced toward an inlet cell (part “91” of FIG. 6) of the unit stack 10 close to the reaction gas inlet/outlet channels, and an amount of the reaction gas introduced toward an distal end cell (part “93” of FIG. 6) thereof far from the reaction gas inlet/outlet channels may be reduced.

During high temperature operation of the fuel cell stack, heat generation may be increased toward the distal end cell portion 93 from the inlet cell portion 91 of the unit stack 93, and a temperature at a section of the distal end cell portion 93 may be increased as compared to a section of the inlet cell portion 91.

However, according to an exemplary embodiment of the present invention, since the unit stack 10, the reaction gas inlet/outlet channels 31 are formed in the first side of the enclosure 30 and the coolant inlet/outlet channels 33 are formed in the second side of the enclosure 30, an amount of the coolant introduced toward the distal end cell portion 93 may be greater than that of the coolant introduced toward the inlet cell portion 91 of the unit stack 10.

As such, since the cooling performance is improved at the distal end cell portion 93 as compared to the inlet cell portion 91 of the unit stack 10, uniform heat generation of the unit stack 10 may be maintained entirely.

In addition, during low temperature operation of the fuel cell stack 100, since a flux of the coolant introduced toward the inlet cell portion 91 of the unit stack 10 through the coolant inlet/outlet channels 33 is less than a flux of the coolant introduced toward the distal end cell portion 93, the super cooling problem of the distal end cell portion 93 may not occur, such that the entire heat balance of the unit stack 10 may be maintained.

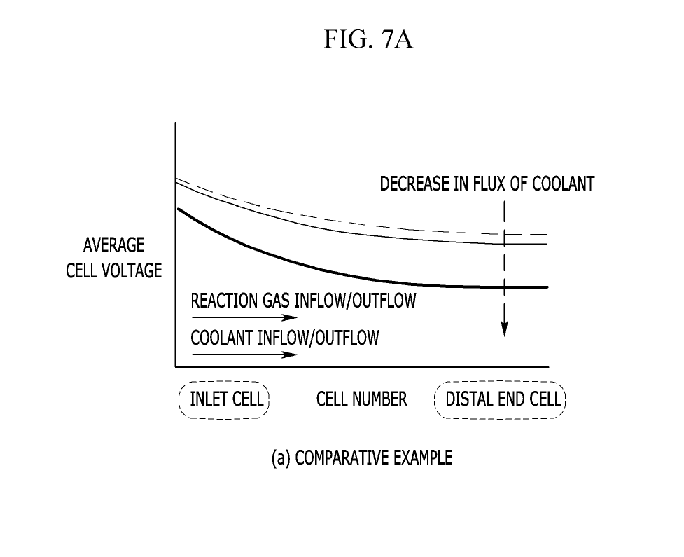

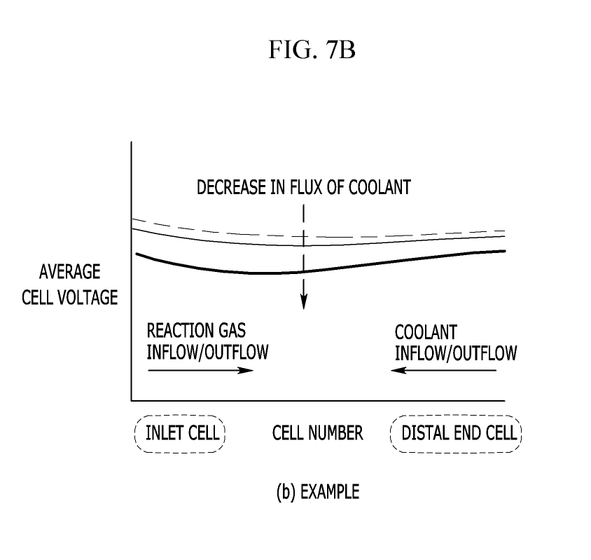

FIGS. 7A and 7B are graphs for comparing average cell voltages of the unit stack depending on a decrease in a flux of the coolant in Comparative Example in which both of the reaction gas inlet/outlet channels and coolant inlet/outlet channels were formed in a single side and Example in which the reaction gas inlet/outlet channels and coolant inlet/outlet channels were formed in both sides, respectively, under a high temperature operation condition.

As shown in FIGS. 7A and 7B, in Example of the present invention, as the reaction gas inlet/outlet channels 31 were formed in the first side of the enclosure 20 and the coolant inlet/outlet channels 31 were formed in the second side of the enclosure 20 based on the unit stack 10, the average cell voltage of the entire unit stack 10 was increased as compared to Comparative Example, and a performance deviation of the unit stack was entirely decreased.

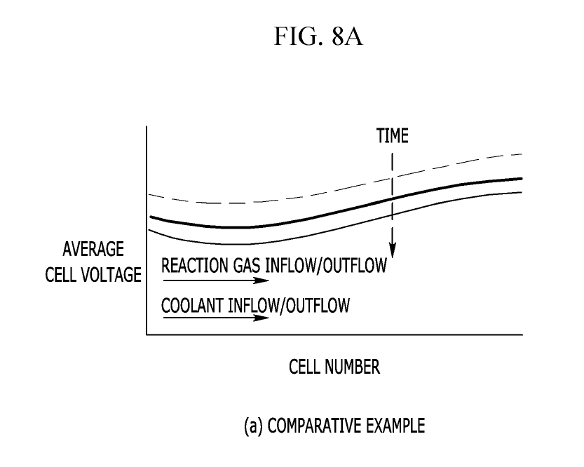

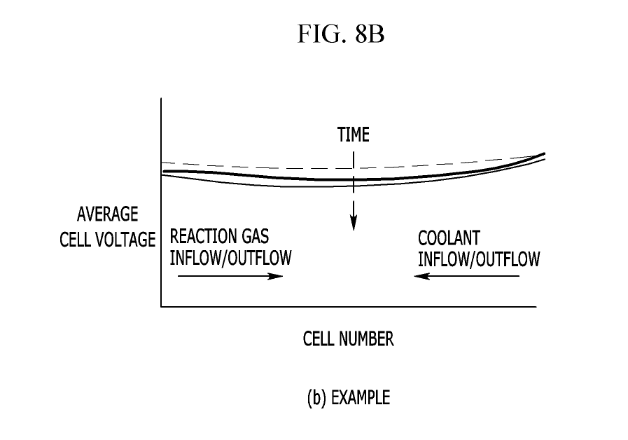

In addition, FIGS. 8A and 8B are graphs for comparing average cell voltages of the unit stack depending on the time in Comparative Example in which both of the reaction gas inlet/outlet channels and coolant inlet/outlet channels were formed in a single side and Example in which the reaction gas inlet/outlet channels and coolant inlet/outlet channels were formed in both sides, respectively, under a low temperature operating condition.

As shown in FIGS. 8A and 8B, in Example of the present invention, as the reaction gas inlet/outlet channels 31 were formed in the first side of the enclosure 20 and the coolant inlet/outlet channels 31 were formed in the second side of the enclosure 20 based on the unit stack 10, performance deterioration between cells at a site where flooding was generated was suppressed as compared to Comparative Example, and performance between the cells was maintained even with the passage of time.

Hereinabove, although exemplary embodiments of the present invention are described, the spirit of the present invention is not limited to the embodiments set forth herein and those skilled in the art and understanding the present invention can easily accomplish other embodiments included in the spirit of the present invention by the addition, modification, and removal of components within the same spirit, but those are construed as being included in the spirit of the present invention.

What is claimed is:

1. A fuel cell stack comprising:
at least one unit stack including an assembly of unit cells; and
an enclosure that protects the unit stack;
wherein reaction gas inlet/outlet channels configured to supply reaction gas to the unit stack are formed in a first side surface of the enclosure, and coolant inlet/outlet channels configured to supply coolant to the unit stack are formed in a second side surface of the enclosure.

2. The fuel cell stack of claim 1, wherein the enclosure includes a first channel block in which the reaction gas inlet/outlet channels are formed and a second channel block in which the coolant inlet/outlet channels are formed.

3. The fuel cell stack of claim 2, wherein the first channel block includes a first side cover of the enclosure, and the second channel block includes a second side cover of the enclosure.

4. A fuel cell stack comprising:
at least one unit stack including an assembly of unit cells; and
an enclosure that protects the unit stack;
wherein the enclosure includes a lower cover that protects a lower portion of the unit stack, a first side cover that protects a first side of the unit stack, a second side cover that protects a second side of the unit stack, and an upper cover that protects an upper portion of the unit stack,
reaction gas inlet/outlet channels that supply reaction gas to the unit stack are formed in the first side cover, and coolant inlet/outlet channels that supply a coolant to the unit stack are formed in the second side cover.

5. The fuel cell stack of claim 4, wherein the first side cover includes a first channel block in which the reaction gas inlet/outlet channels are formed and the first side cover is fixed to a predetermined mounting part, and
the second side cover includes a second channel block in which the coolant inlet/outlet channels are formed and the second side cover is fixed to the mounting part.

6. The fuel cell stack of claim 5, wherein a mount bracket fixed to the mounting part is formed integrally with the first side cover and the second side cover.

7. The fuel cell stack of claim 5, wherein the first channel block is connected to the first side of the unit stack through the reaction gas inlet/outlet channel, and
the second channel block is connected to the second side of the unit stack through the coolant inlet/outlet channel.

8. The fuel cell stack of claim 4, wherein the lower cover is formed in a “ [symbol] ”, “ [symbol] ”, or “ [symbol] ” cross-sectional shape and is configured to enclose and protect lower portions of the unit stack, the first side cover and the second side cover.

9. The fuel cell stack of claim 8, wherein the upper cover is formed in a “ [symbol] ” or “ [symbol] ” cross-sectional shape and is configured to enclose and protect upper portions of the unit stack, the first side cover and the second side cover.

10. A fuel cell system comprising a fuel cell stack of claim 1.

11. A vehicle comprising a fuel cell system of claim 10.

12. An assembly of a fuel cell stack of claim 1.
